(19) United States
(12) Patent Application Publication
(10) Pub. No.: US 2006/0229198 A1
(43) Pub. Date: Oct. 12, 2006

(54) Noble metal alloy formation method to improve stability

(76) Inventors: Stephen J. McCarthy, Center Valley, PA (US); Jean W. Beeckman, Columbia, MD (US)

Correspondence Address: ExxonMobil Research and Engineering Company, P.O. Box 900, Annandale, NJ, 08801-0900, US

(21) Appl. No.: 11/388,807

(22) Filed: Mar. 24, 2006

Related U.S. Application Data
(60) Provisional application No. 60/669,846, filed on Apr. 8, 2005.

(51) Int. Cl. B01J 23/40

(52) U.S. Cl. 502/325

(57) ABSTRACT

The present invention is a method to form a noble metal catalyst including two noble metals alloy on a catalyst support. The steps include impregnating a first noble metal onto said catalyst support, and thereafter impregnating a second noble metal onto said catalyst support. In a preferred embodiment, the first noble metal is palladium and the second noble metal is platinum.

This application claims the benefit of U.S. Provisional application 60/669,846 filed Apr. 8, 2005.

### BACKGROUND OF THE INVENTION

The present invention relates to a method for forming a catalyst on a catalyst support. In particular, the present invention relates to a platinum and palladium catalyst on a zeolite support.

Supported platinum/palladium alloys are used primarily for hydrogenation of aromatic containing hydrocarbons, including lubes basestocks. During on-stream operation, catalyst activity declines due to sintering, which occurs when finely dispersed platinum and palladium particles agglomerate and active metals surface area is reduced. Reactor temperature must then be increased to maintain constant product quality. Eventually, end of cycle temperatures are reached and the unit must be shutdown to replace the catalyst. The present invention relates to a novel method for forming the original platinum and palladium alloy, during catalyst manufacture that will significantly improve catalyst stability and increase catalyst life by reducing agglomeration tendencies. Improving catalyst stability will significantly increase useful life and, therefore, reduce operating costs related to catalyst replacement.

### SUMMARY OF THE INVENTION

The present invention is a noble metal catalyst including two noble metals. In a preferred embodiment, the method forms a stable platinum and palladium alloy on a catalyst support. The method includes the steps of impregnating palladium onto the catalyst support and, thereafter, impregnating platinum onto the catalyst support. In a preferred embodiment, the impregnated catalyst is dried in air after impregnating palladium onto the support. The impregnated catalyst support was dried in air and calcined in air at about 580° F. after the platinum impregnating step. The catalyst support may be a zeolite support.

In a preferred embodiment, the supported metal catalyst is palladium and platinum supported on MCM-41 bound with alumina, which is described in U.S. Pat. No. 5,098,684.

### DETAILED DESCRIPTION OF THE PREFERRED EMBODIMENTS

The present invention relates to a novel method for platinum and palladium alloy formation on catalyst supports that significantly improves catalyst stability. Better catalyst stability will increase useful catalyst life and, therefore, reduce operating costs related to catalyst replacement. In particular, the method relates to platinum and palladium alloys formed by impregnation of platinum and palladium complexes onto mesoporous and zeolite supports. However, the technique should apply to all catalysts where platinum and palladium are impregnated onto catalytic supports to form active alloys.

Currently, most platinum and palladium catalysts are made by co-impregnating platinum and palladium complexes onto a catalytic support. The catalyst is then dried to remove water and then calcined in air to decompose the metal complexes leaving behind highly dispersed platinum and palladium oxides on the support surface. The noble metal oxides are then reduced in the presence of hydrogen to produce the active platinum and palladium alloys. These platinum/palladium alloy catalysts are used primarily for hydrogenation of hydrocarbons. During on-stream operation, catalyst activity declines due to sintering, which occurs when finely dispersed platinum and palladium particles agglomerate and active metals surface area is reduced. The present invention relates to a novel method for forming the original platinum and palladium alloy, during catalyst manufacture that will significantly improve catalyst stability and increase catalyst life by reducing agglomeration tendencies.

In a preferred embodiment, the catalyst consists of 0.3 wt % platinum and 0.9 wt % palladium alloy supported on MCM-41 bound with alumina. The platinum and palladium alloy is formed by co-impregnating the alumina bound MCM-41 support with an aqueous solution of platinum and palladium tetra amine nitrate. The catalyst is dried and then calcined in air to decompose the tetra amine complexes and leave behind a finely dispersed platinum and palladium alloy on the surface.

The method of platinum and palladium impregnation has an impact on the stability of the platinum and palladium alloy. First, we co-impregnated a support, 65 wt % MCM-41 and 35 wt % alumina, with sufficient platinum and palladium tetra amine nitrate to produce a calcined catalyst with a 0.3 wt % platinum and 0.9 wt % palladium alloy (conventional catalyst). The coated catalyst was dried and then calcined in air at about 580° F. to decompose the tetra amine complexes and form a finely dispersed platinum and palladium alloy on the support surface. As shown in the table below, the oxygen chemisorption of this catalyst after hydrogen reduction, 0.65 moles of oxygen per mole of metal, indicates that the platinum and palladium alloy were highly dispersed. This catalyst was then steamed (100% steam) at 500° F. and 800° to simulate the agglomeration of these metals that would occur during on-stream operation. After steaming at both of these conditions, the catalyst lost a significant amount of metal surface area as indicated by the significantly lower amount of oxygen that could be adsorbed on the metal surface following reduction in hydrogen.

0.3 wt % Platinum and 0.9 wt % Palladium
on MCM-41 Support bound with Alumina

| | Oxygen Chemisorption, O/M | | |
|---|---|---|---|
| Method of | Calcined at | Steamed at | Steamed at |
| Impregnation | 580° F. | 500° F. | 800° F. |
| Co-impregnation | 0.65 | 0.33 | 0.16 |
| Pt and then Pd | 0.67 | 0.38 | 0.18 |
| Pd and then Pt | 0.60 | 0.59 | 0.45 |

We next impregnated platinum and palladium onto the MCM-41 bound with alumina support in two separate impregnation steps. In one case, the support was first impregnated with platinum and then palladium. In the second case, the support was first impregnated with palladium and then platinum. Between impregnation steps, the coated catalysts were dried in air. After the second impregnation, the coated catalysts were dried and then calcined in air at about 580° F. to decompose the tetra amine complexes and form a finely dispersed platinum and palladium alloy on the support surface. As shown in the table above, the oxygen chemisorptions of these catalysts after hydrogen reduction were equivalent to the conventional catalyst made via co-impregnation.

Both calcined catalysts were then steamed (100% steam) at 500° F. and 800° F. to simulate the agglomeration of these metals that would occur during on-stream operation. The catalyst first impregnated with platinum and then palladium showed no improvement in stability and, like the conventional catalyst, lost a significant amount of metals surface area upon steaming. However, the catalyst first impregnated with palladium and then platinum showed remarkable stability and lost significantly less metal surface area upon steaming. As shown in the table above, the catalyst completely retained metal surface area after steaming at 500° F. and only lost about 25% of metal surface area after steaming at 800° F. For comparison, the conventional catalyst lost more than 75% of the metal surface area after steaming at 800° F.

The discussion above clearly demonstrates that modifying the method of forming the original platinum and palladium alloy on the support surface, during catalyst manufacture, can significantly improve catalyst stability and increase catalyst life by reducing agglomeration tendencies of the alloy metals. The present invention of a novel method for platinum and palladium alloy formation on catalyst supports significantly improves catalyst stability.

What is claimed is:

1. A method to form a noble metal catalyst including two noble metals on a catalyst support comprising:
(a) impregnating a first noble metal onto said catalyst support, and thereafter
(b) impregnating a second noble metal onto said catalyst support.

2. The method of claim 1 wherein said impregnated catalyst support is dried after step (a) to remove water.

3. The method of claim 2 wherein said catalyst support was calcined at temperatures below 800° F.

4. The method of claim 1 wherein said impregnated catalyst support was dried after step (b) to remove water.

5. The method of claim 3 wherein said catalyst support was calcined in air at about 580° F. after step (b).

6. The method of claim 1 wherein said catalyst support is a zeolite support.

7. The method of claim 1 wherein said two noble metals are palladium and platinum.

8. The method of claim 1 wherein said first noble metal is palladium and said second noble metal is platinum.

9. The method of claim 3 wherein said temperatures are below 700° F.

10. The method of claim 3 wherein said temperatures are below 650° F.
